(19) United States
(12) Patent Application Publication
(10) Pub. No.: US 2015/0278803 A1
(43) Pub. Date: Oct. 1, 2015

(54) NEAR FIELD COMMUNICATION FIELD DETECTION

(71) Applicant: GOOGLE INC., Mountain View, CA (US)

(72) Inventors: Janesh A. Champaneria, Keller, TX (US); Aman M. Parekh, Coppell, TX (US)

(21) Appl. No.: 14/673,760

(22) Filed: Mar. 30, 2015

Related U.S. Application Data
(60) Provisional application No. 61/971,832, filed on Mar. 28, 2014.

(51) Int. Cl. G06Q 20/36; H04M 1/725; G06Q 20/20; G06Q 20/32

(52) U.S. Cl. CPC G06Q 20/36; G06Q 20/3278; H04M 1/7253; G06Q 20/204; G06Q 20/202

(57) ABSTRACT

Determining near field communication (“NFC”) field strength when conducting an NFC transaction with a point of sale (“POS”) terminal comprises a user computing device that provides a display on a user interface. The display provides to the user an indication of the intensity of the NFC field strength. The display may be a graph or other indicator of intensity, such as a gauge, meter, scale, or other indicator representation. As the user moves the user computing device around the surface of the POS terminal, the display reflects the NFC field strength in the corresponding location. The user may use the display to locate the position of the POS terminal relative to the user computing device that provides the greatest NFC field strength or a sufficient NFC signal strength. If the field strength exceeds a configured threshold, then a digital wallet application is initiated.

### CROSS REFERENCE TO RELATED APPLICATION

This application claims priority to U.S. Provisional Patent Application No. 61/971,832 filed Mar. 28, 2014, and entitled “Systems, Methods, and Computer Program Products for Detecting NFC Enabled Terminals,” the entire contents of which are hereby fully incorporated herein by reference.

### TECHNICAL FIELD

The technology disclosed herein pertains to providing a user interface on a user computing device to display an intensity of a near field communication signal to improve the process of properly positioning the user computing device near a point of sale terminal.

### BACKGROUND

Near field communication (“NFC”) and other wireless technologies are utilized by many point of sale (“POS”) terminals and other computing devices. The POS terminals use NFC technologies to communicate to user computing devices to conduct transactions, receive account data, transmit pricing and receipts, and perform other related tasks. Other computing devices may use NFC technologies to transmit offers, coupons, or other marketing materials.

Different POS terminals may emit an NFC signal from different parts of the POS terminal. For example, certain POS terminals may transmit from the top of the terminal, while others may transmit from the side. It may be confusing to a user who has never used a particular POS terminal before. The user may be unable to locate the optimal position to hold the user computing device. Further, the user may not know to location of an antenna on the user computing device. Thus, the user may not be able to position the optimal part of the user computing device over the optimal part of the POS terminal.

### SUMMARY

Techniques herein provide computer-implemented methods to determine NFC field strength when conducting an NFC transaction. In an example embodiment, a user computing device receives a wireless transmission from a point of sale terminal, initiates a wireless transmission signal strength user interface, and displays the wireless transmission signal strength on the user interface. The user computing device determines that the wireless transmission signal strength meets or exceeds a configured threshold and communicates a notification that the wireless transmission signal strength is above the configured threshold. The user computing device opens the digital wallet application and/or moves the digital wallet application to the front of the user interface in response to the determination that the wireless transmission signal strength meets or exceeds a configured threshold.

In certain other example aspects described herein, systems and computer program products to determine NFC field strength when conducting an NFC transaction are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to determine NFC field strength when conducting an NFC transaction, in accordance with certain example embodiments of the technology disclosed herein.

FIG. 2 is a block flow diagram depicting methods to determine NFC field strength when conducting an NFC transaction, in accordance with certain example embodiments.

FIG. 3 is a block flow diagram depicting methods to configure an account at payment processing system, in accordance with certain example embodiments.

FIG. 4 is an illustration of a user computing device displaying a signal strength indicator, in accordance with certain example embodiments.

FIG. 5 is an illustration of a user computing device displaying a signal strength indicator, in accordance with certain example embodiments.

FIG. 6 is a block diagram depicting a computing machine and a module, in accordance with certain example embodiments.

### DETAILED DESCRIPTION OF THE EXAMPLE EMBODIMENTS

### Overview

Embodiments herein provide computer-implemented techniques to determine near field communication (“NFC”) field strength when conducting an NFC transaction with a point of sale (“POS”) terminal. A user computing device provides a display to a user on a user interface. The display provides to the user an indication of the intensity of the NFC field strength. The display may be a graph or other indicator of intensity, such as a gauge, meter, scale, or other indicator representation.

As the user moves the user computing device above the surface of the POS terminal, the display reflects the NFC field strength in that corresponding location. The user may attempt to locate the position of the POS terminal that provides the greatest NFC field strength. The concepts and methods described herein with regards to NFC transmissions may be applied to the detection of any type of wireless signal or transmission. In certain embodiments, the wireless signal may be generated by any other suitable wireless technology, such as Bluetooth, Wi-Fi, or infrared.

The user interface may provide an alert to the user when the NFC field strength is above a required threshold. For example, the alert may be a vibration, audible alert, or a visual indication. In certain embodiments, upon detecting that the user computing device is receiving NFC signals, the user computing device surfaces the digital wallet application module to the front of the user interface. That is, the user computing device opens the digital wallet, if the digital wallet is not already open, for interaction by the user. If the digital wallet is open, but in the background of the user interface, the user computing device moves the digital wallet to the front of the user interface and makes the digital wallet the primary application.

In certain examples, a POS terminal may not emit a signal of sufficient intensity that a transaction may be safely and securely conducted. For example, a POS terminal may be old, broken, or otherwise impaired. For certain POS terminals, a user computing device placement does not exist that would provide a sufficient NFC field strength. The NFC field strength indicator would allow a user to recognize the impaired signal strength and prevent the user from repeatedly attempting the transaction.

By using and relying on the methods and systems described herein, the NFC field strength display allows a user to dynamically determine the proper location to place a user computing device relative to an NFC reader of a POS terminal to obtain an optimal or sufficient signal. As such, the systems and methods described herein may be employed to allow the user to conduct transactions or conduct other communications in a safer and more efficient manner. For example, this action allows the user to provide account data to and receive transaction information from the POS terminal with less interruption in service and with more accurate data transmissions. Hence, the methods and systems described herein permit improved communications by directing user computing device placements on POS terminals.

### Example System Architecture

Turning now to the drawings, in which like numerals represent like (but not necessarily identical) elements throughout the figures, example embodiments are described in detail.

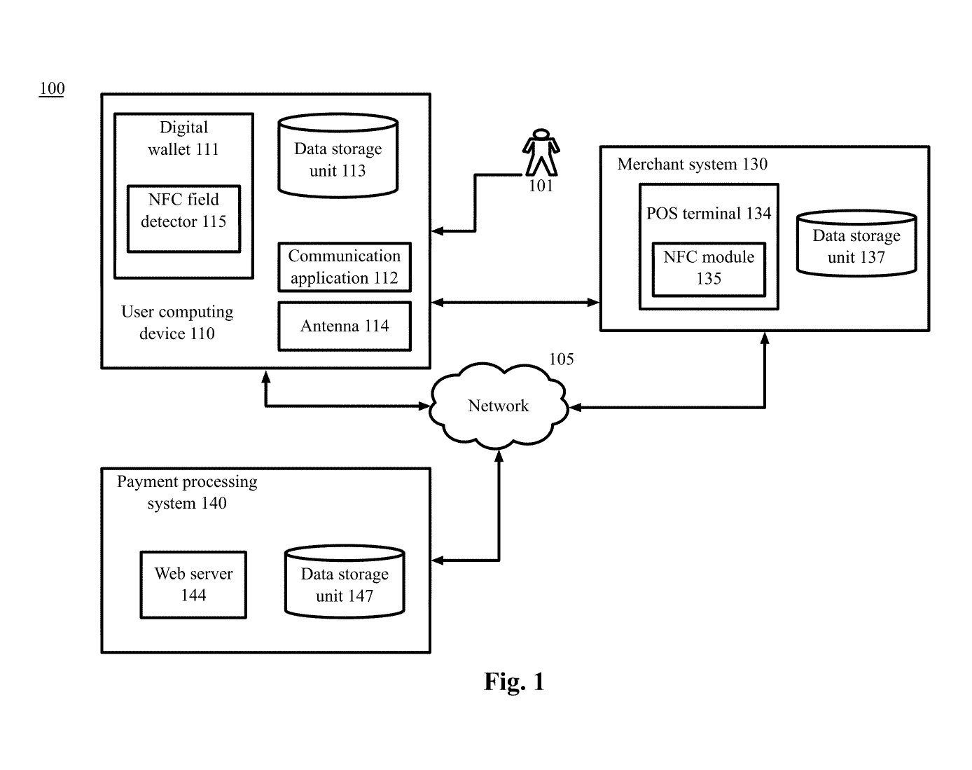

FIG. 1 is a block diagram depicting a system 100 to determine NFC field strength when conducting an NFC transaction, in accordance with certain example embodiments. As depicted in FIG. 1, the system 100 includes network computing systems 110, 130, and 140 that are configured to communicate with one another via one or more networks 105. In some embodiments, a user associated with a device must install an application and/or make a feature selection to obtain the benefits of the techniques described herein.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network computing system 110, 130, and 140 includes a device having a communication module capable of transmitting and receiving data over the network 105. For example, each network device 110, 130, and 140 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 130, and 140 are operated by users 101 or consumers, merchant system operators, and payment processing system operators, respectively.

The user 101 can use the communication application 112, which may be, for example, a web browser application or a stand-alone application, to view, download, upload, or otherwise access documents or web pages via a distributed network 105. The network 105 includes a wired or wireless telecommunication system or device by which network devices (including devices 110, 130, and 140) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The user 101 can use the communication application 112, which may be, for example, a web browser application or a stand-alone application, to view, download, upload, or otherwise access documents or web pages via a distributed network 105. The communication application 112 can interact with web servers or other computing devices connected to the network 105, including the point of sale terminal 134 of the merchant system 130 and the web server 144 of the payment processing system 140. The user computing device 110 may include a digital wallet application module 111. The digital wallet application module 111 may encompass any application, hardware, software, or process the user device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112.

The digital wallet application module 111 may comprise a near field communication (“NFC”) field detector 115. The NFC field detector 115 may represent the hardware and software required to receive, identify, and interpret NFC communications. The NFC field detector 115 may utilize a graph or other indicator of intensity, such as a gauge, meter, scale, or other indicator representation to display the NFC field strength.

The user computing device 110 may employ an antenna 114 for use in detecting the NFC transmission. The antenna 114, in combination with the NFC field detector 115, may be configured to listen for NFC transmissions, receive NFC transmissions, and to transmit NFC transmissions.

The NFC field detector 115 may display the intensity of the NFC field by varying the color of a display, by moving the needle of a gauge, by varying the height of a bar, by varying a digital readout such as a percentage of intensity, or by any other suitable indication of intensity. Additionally, the NFC field detector 115 may combine one or more display outputs. The display associated with the NFC field detector 115 displays to a user 101 the intensity of the NFC field at the location of the user computing device 110. As the user computing device 110 is moved about the surface of the POS terminal, the intensity, and thus the display, will vary. In an example, the intensity of the NFC field is measured based on the signal strength of the NFC signal as measured by the NFC field detector 115 via the antenna. In an example, the intensity of the NFC field is based on a measurement of the signal in A/m.

The user device 110 includes a data storage unit 113 accessible by the NFC field detector 115, the web browser application 112, or any suitable computing device or application. The exemplary data storage unit 113 can include one or more tangible computer-readable media. The data storage unit 113 can be stored on the user device 110 or can be logically coupled to the user device 110. For example, the data storage unit 113 can include on-board flash memory and/or one or more removable memory cards or removable flash memory.

The payment processing system 140 includes a data storage unit 147 accessible by the web server 144. The example data storage unit 147 can include one or more tangible computer-readable storage devices. The payment processing system 140 is operable to conduct payments between a user 101 and a merchant system 130. The payment processing system 140 is further operable to manage a payment account of a user 101, maintain a database to store transactions of the merchant system and the user 101, verify transactions, and other suitable functions.

The user 101 may interact with a web server 144 on the payment processing system 140 to view, register, download, upload, or otherwise access the payment processing system 140 via a website (not illustrated) and a communication network 105. The user 101 associates one or more registered financial card accounts, including bank account debit cards, credit cards, gift cards, loyalty cards, coupons, offers, prepaid offers, store rewards cards, or other type of financial account that can be used to make a purchase or redeem value-added services with a payment account of the user 101.

A card issuer, such as a bank or other institution, may be the issuer of the financial account being registered. For example, the card issuer may be a gift card issuer, credit card issuer, a debit card issuer, a stored value issuer, a financial institution providing an account, or any other provider of a financial account. The payment processing system 140 also may function as the issuer for the associated financial account. The user's registration information is saved in the payment processing system's 140 data storage unit 147 and is accessible the by web server 144. The card issuer employs a card issuer system (not pictured) to issue the cards, manage the user account, and perform any other suitable functions. The card issuer system may alternatively issue cards used for identification, access, verification, ticketing, or cards for any suitable purpose.

The user 101 may request a purchase from the merchant system 130. The merchant system 130 may be any store, institution, vendor, facility, or other type of merchant system 130. The merchant system 130 may be a physical location of a store, a kiosk, a mobile vendor, or any suitable system. In an example embodiment, the purchase is initiated by a wireless “tap” of the user computing device 110 with an NFC reader XXX of the POS terminal 134. The merchant's POS terminal 134 interacts with an acquirer, the card network, the payment processing system 140, and the issuer to conduct a transaction.

The POS terminal 134 may have a display for users 101 and merchant system operators, a scanner or other digital readers, connections to various servers or other computing systems, or any other suitable hardware and software. The POS terminal 134 may comprise an NFC module 135. The NFC module 135 may comprise NFC technology for communicating with the user computing device. The NFC module 135 may be a module of the POS terminal 134, a separate device, a remote device, or configured in any other suitable arrangement. In an example wherein the NFC module 135 is a function of the POS terminal 134, the POS terminal 134 may have an internal or external antenna for NFC communications and may further display a sticker, label, or other notification of the proper position to place a user computing device to conduct an NFC transaction. In an example, where the NFC module 135 is a separate device from the POS terminal 134, the NFC module 135 may have an internal or external antenna for NFC communications.

The concepts and methods described herein with regards to NFC transmissions may be applied to the detection of any type of wireless signal or transmission. In certain embodiments, the wireless signal may be generated by any other suitable wireless technology, such as Bluetooth, Wi-Fi, or infrared. Any suitable communication technology may be utilized in lieu of the NFC technologies described in the examples herein. The NFC module 135 may represent the hardware and software for transmitting, receiving, and interpreting any needed NFC functions for conducting transactions or providing other transmissions.

It will be appreciated that the network connections shown are example and other means of establishing a communications link between the computers and devices can be used. Additionally, those having ordinary skill in the art having the benefit of the present disclosure will appreciate that the merchant system 130, payment processing system 140, and the user computing device 110 illustrated in FIG. 1 can have any of several other suitable computer system configurations. For example, a user computing device 110 embodied as a mobile phone or handheld computer may not include all the components described above.

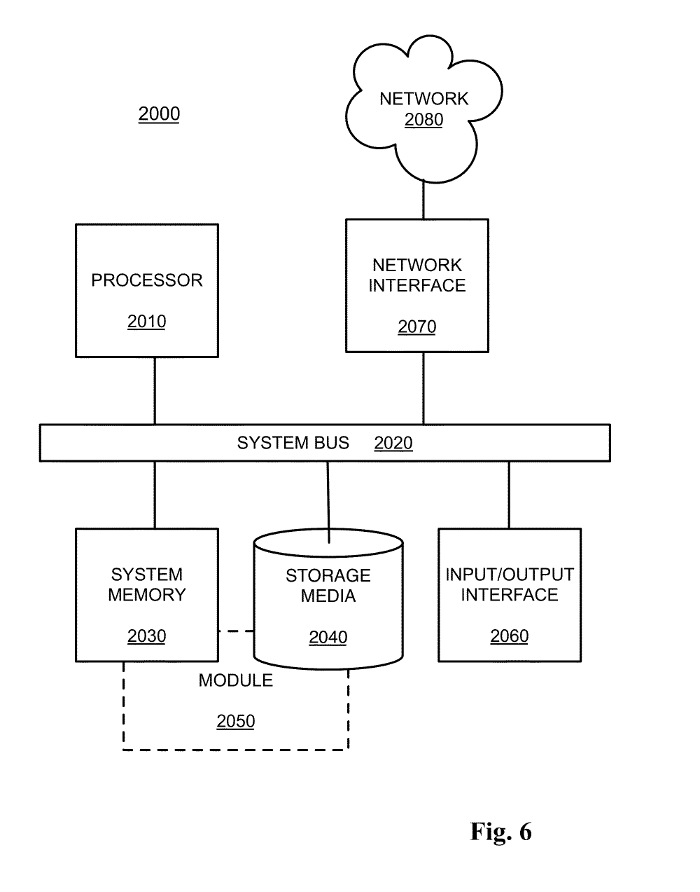

In example embodiments, the network computing devices and any other computing machines associated with the technology presented herein may be any type of computing machine such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may by any of the modules discussed in more detail with respect to FIG. 6. The computing machines discussed herein may communicate with one another as well as other computer machines or communication systems over one or more networks, such as network 105. The network 105 may include any type of data or communications network, including any of the network technology discussed with respect to FIG. 6.

### Example Processes

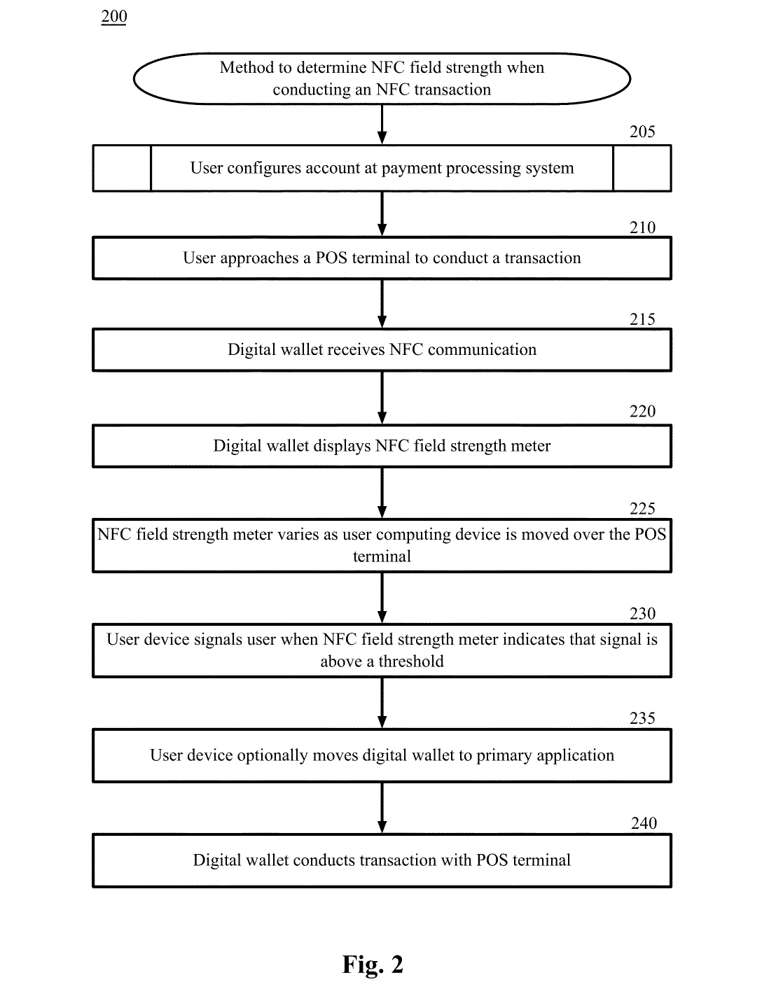

The example methods illustrated in FIGS. 2-5 are described hereinafter with reference to the components of the example operating environment 100. The example methods of FIGS. 2-5 may also be performed with other systems and in other environments.

FIG. 2 is a block flow diagram depicting a method 200 to determine NFC field strength when conducting an near field communication (“NFC”) transaction, in accordance with certain exemplary embodiments. The method 200 is described with reference to the components illustrated in FIG. 1.

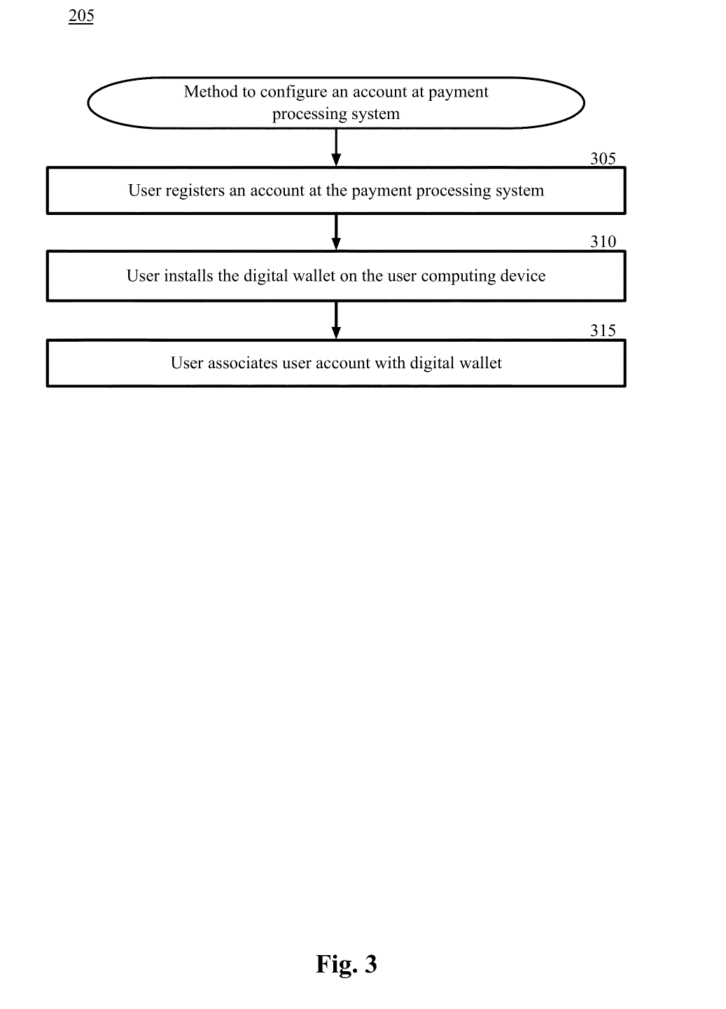

In block 205, a user 101 configures an account at a payment processing system 140. Block 205 is described in greater detail hereinafter with reference to the method 205 described in FIG. 3.

FIG. 3 is a block diagram depicting the method 205 for a user 101 to configure an account at payment processing system 140, in accordance with certain example embodiments. The method 205 is described with reference to the components illustrated in FIG. 1

In block 305, the user 101 registers an account at the payment processing system 140. For example, the user 101 may access the payment processing system 140 and enter account information. The user 101 may configure an account for which a financial account already exists, such as a credit card account. Alternatively, the user 101 may register a new account. The user 101 may configure the account for conducting transactions with a digital wallet application module 111 or other component of a user computing device 110.

In block 310, the user 101 installs a digital wallet on the user computing device 110. The digital wallet application module 111 may encompass any application, hardware, software, or process the user device 110 may employ to assist the user 101 in completing a purchase. The digital wallet application module 111 can interact with the communication application 112 or can be embodied as a companion application of the communication application 112.

The digital wallet application module 111 may comprise an NFC field detector 115. The NFC field detector 115 may provide data to the user interface of the user computing device 110 to display a graph or other indicator of intensity, such as a gauge, meter, scale, or other indicator representation. The display may be presented on the user interface associated with the digital wallet application module 111, a stand alone application, or on any suitable user interface system. The user computing device 110 may display the intensity of the NFC field by varying the color of a display, by moving the needle of a gauge, by varying the height of a bar, by varying a digital readout such as a percentage of intensity, or by any other suitable indication of intensity. Additionally, the NFC field detector 115 may combine one or more display outputs. The NFC field detector 115 displays to a user 101 the intensity of the NFC field at the location of the user computing device 110. As the user computing device 110 is moved about the surface of the POS terminal, the intensity, and thus the display, will vary.

In block 315, the user 101 associates the user account with the digital wallet application module 111. The user 101 may configure the digital wallet application module 111 to conduct transactions using the user account that is configured on the payment processing system 140.

From block 315, the method 205 returns to block 210 of FIG. 2.

Returning to FIG. 2, in block 210, the user 101 approaches a point of sale (“POS”) terminal 134 to conduct a transaction. For example, the user 101 may enter a merchant system facility, such as a physical store, and select a product for purchase. The user 101 presents the product to a salesperson, kiosk, or other checkout location. The salesperson may scan the item into the POS terminal 134 to begin a sales transaction.

In block 215, the digital wallet application module 111 receives an NFC communication from the POS terminal 134. In an example, the user 101 places the user computing device 110 near the POS terminal 134 within a range dictated by the NFC technology being utilized. The NFC module 135 of the merchant system 130 may comprise NFC technology to communicate with the user computing device 110. The NFC module 135 may represent the hardware and software for transmitting, receiving, and interpreting any needed NFC functions for conducting transactions or providing other transmissions.

The user computing device 110 receives the NFC transmission from the POS terminal 134. The NFC transmission is received and recognized by the NFC field detector 115 of the user computing device 110. In an example, the NFC module 135 of the POS terminal 134 transmits an NFC signal via an antenna. The antenna 108 of the user computing device 110 receives the NFC signal. The NFC field detector 115 or another component of the user computing device 110 recognizes the NFC signal.

In block 220, the digital wallet application module 111 displays the NFC field strength meter. The digital wallet application module 111 may utilize an NFC field detector 115. The NFC field detector 115 may be a function of an application other than the digital wallet application module 111, or the NFC field detector 115 may be a stand alone application or module. The NFC field detector 115 may be the hardware and software required to receive, identify, and interpret, NFC communications. The NFC field detector 115 may utilize a graph or other indicator of intensity, such as a gauge, meter, scale, or other indicator representation to display the NFC field strength. The NFC field detector 115 may be a graph or other indicator of intensity, such as a gauge, meter, scale, or other indicator representation. The NFC field detector 115 may display the intensity of the NFC field by varying the color of a display, by moving the needle of a gauge, by varying the height of a bar, by varying a digital readout such as a percentage of intensity, or by any other suitable indication of intensity. Additionally, the NFC field detector 115 may combine one or more display outputs. The NFC field detector 115 displays to a user 101 the intensity of the NFC field at the location of the user computing device 110. As the user computing device 110 is moved about the surface of the POS terminal, the intensity, and thus the display, will vary.

In the example, the NFC field detector 115 displays the NFC field strength at the location on the surface of the POS terminal 135 where the user 101 is holding the user computing device 110.

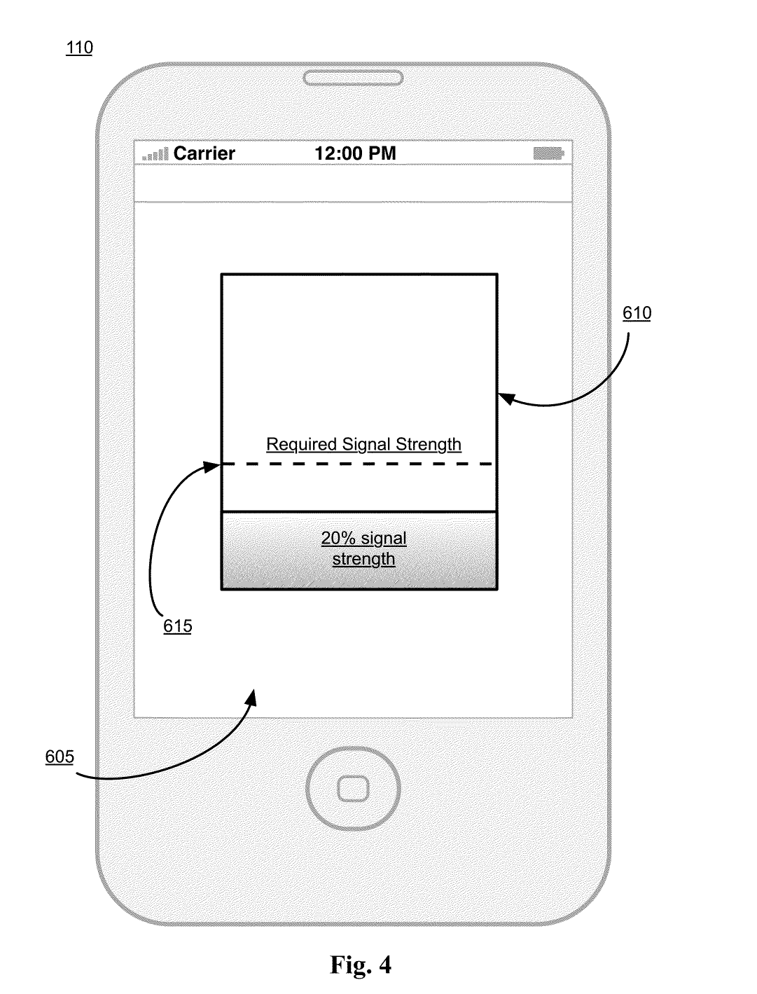

An example illustration of the NFC field strength display as shown on the user interface 605 of the user computing device 110 is presented in FIG. 4. In FIG. 4, a user computing device 110 is shown displaying a bar indicator 610 of the NFC field strength. The signal strength as shown is represented on the bar as 20% of the maximum field strength. In the example of FIG. 4, the required signal strength 615 of the NFC field is approximately 40%, and the signal strength of 20% is not sufficient for a secure transaction. The required signal strength may be what is needed to communicate information to and from the POS terminal 134 or the NFC module 135 in a configured amount of time to conduct a transaction with the merchant system 130.

Returning to FIG. 2, in block 225, the NFC field strength meter varies as the user computing device 110 is moved over the POS terminal 134. The user 101 may hold various portions of the user computing device 110 over various portions of the NFC module 135 of the POS terminal 134 to test the NFC field strength. For example, the user 101 may hold the user computing device 110 over the face of the POS terminal 134 and move the user computing device 110 to various positions over the face. Additionally, the user 101 may hold the user computing device 110 over the top of the POS terminal 134, then the bottom, then the two sides, and or in any other suitable position of the POS terminal 134. The user 101 may observe the changes in the NFC field strength at the various locations. If the NFC module 135 is a separate device, then the user may position the user computing device 110 in similar positions with respect to the NFC module 135.

In certain embodiments, the user 101 places the user computing device 110 in a location that has sufficient NFC field strength and does not need to test other locations of the POS terminal 134. In another example, the user 101 varies the distance that the user computing device 110 is held away from the POS terminal 134, such as 1 inch, 2 inches, or 6 inches.

In an example, the NFC field strength display varies as the user computing device 110 moves from higher strength NFC field strength locations to lower strength NFC field strength locations and vice versa.

In block 230, the user computing device 110 signals the user 101 when the NFC field strength meter indicates that signal is above a configured threshold. A threshold NFC field strength value may be configured in the user computing device 110 by the user 101, by the payment processing system 140, by a provider of the digital wallet application module 111, by a provider of the NFC field detector 115 hardware or software, or by any other suitable party. The threshold is at least set at a signal strength that is needed to communicate information to and from the POS terminal 134 or the NFC module 135 in a configured amount of time to conduct a transaction with the merchant system 130. In an example with 7.5 A/m being the maximum field strength, a threshold field strength of 1.5 A/m is required. That is, if the NFC field strength is at or above 1.5 A/m, then the meter will indicate that the signal is sufficient for a secure transaction.

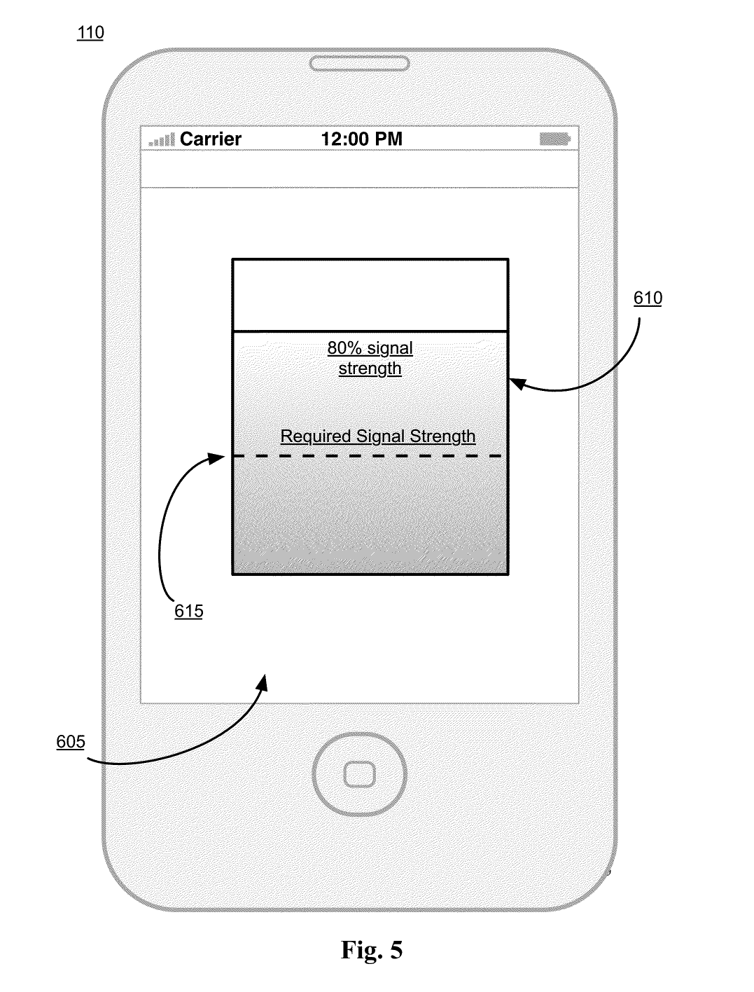

Another example illustration of the NFC field strength display as shown on the user interface 605 of the user computing device 110 is presented in FIG. 5. In FIG. 5, a user computing device 110 is shown displaying a bar indicator 610 of the NFC field strength. The signal strength as shown is represented on the bar as 80% of the maximum field strength. In the example of FIG. 5, the required signal strength 615 of the NFC field is approximately 40% and the signal strength of 80% is sufficient for a secure transaction. The required signal strength may be what is needed to communicate information to and from the POS terminal 134 or the NFC module 135 in a configured amount of time to conduct a transaction with the merchant system 130.

Returning to FIG. 2, upon detecting that the user computing device is receiving NFC signals, the user computing device 110 optionally surfaces the digital wallet application module 111 to the primary application. For example, the user computing device 110 surfaces the digital wallet application module 111 to the front of the user interface. That is, the user computing device 110 opens the digital wallet application module 111, if the digital wallet application module 111 is not already open, for interaction by the user 101. If the digital wallet application module 111 is open, but is in the background of the user interface, the user computing device 110 moves the digital wallet application module 111 to the front of the user interface and makes the digital wallet application module 111 the primary application. Other open applications are moved into the background behind the digital wallet application module 111.

In block 240, the digital wallet application module 111 conducts the transaction with the POS terminal 134. After a sufficient connection is located, the digital wallet application module 111 and the POS terminal 134 transmit information between each other sufficient to conduct the transaction. For example, the POS terminal 134 may transmit the request for account information, transaction details such as funds required, a receipt, and any other suitable information. The digital wallet application module 111 may transmit to the POS terminal 134 data such as account information, security data, user information, and any other suitable information.

The POS terminal 134 may transmit an authorization request to the payment processing system 140 to complete the transaction. The authorization request will include account information, such as the account number, that is received by the POS terminal 134 from the user computing device 110 via NFC. The payment processing system authorizes the transaction based on the included account information.

### OTHER EXAMPLE EMBODIMENTS

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to determine wireless field strength when conducting a wireless transaction, comprising:
receiving, by the one or more computing devices, a wireless transmission from a point of sale terminal;
initiating, by the one or more computing devices, a wireless transmission signal strength user interface in response to receiving the wireless transmission from the point of sale terminal;
determining, by the one or more computing devices, a strength of the wireless transmission received from the point of sale terminal;
displaying, by the one or more computing devices, the determined wireless transmission strength on the wireless transmission signal strength user interface;
determining, by the one or more computing devices, that the determined wireless transmission strength meets or exceeds a configured threshold;
communicating, by the one or more computing devices, a notification that the wireless transmission signal strength meets or exceeds the configured threshold; and
initiating, by the one or more computing devices, a digital wallet application in response to the determination that the wireless transmission strength meets or exceeds the configured threshold.

2. The method of claim 1, wherein the notification is a vibration or an audible alert.

3. The method of claim 1, further comprising presenting, by the one or more computing devices, the digital wallet application on the user interface as the primary application in response to the determination that the wireless transmission signal meets or exceeds the configured threshold.

4. The method of claim 2, wherein the wireless transmission is a near field communication transmission.

5. The method of claim 2, wherein the wireless transmission is a Bluetooth, Wi-Fi, or infrared transmission.

6. The method of claim 1, wherein the wireless transmission strength displayed on the user interface is a bar graph indicating the strength of the wireless transmission.

7. The method of claim 1, wherein the wireless transmission strength displayed on the user interface is a meter, gauge, or numerical representation indicating the strength of the wireless transmission.

8. A computer program product, comprising:
a non-transitory computer-readable storage device comprising computer-readable program instructions embodied therein that when executed by a computer cause the computer to determine NFC field strength when conducting a wireless transaction, the computer-readable program instructions comprising:
computer-readable program instructions to receive a NFC transmission from a point of sale terminal;
computer-readable program instructions to initiate a NFC transmission signal strength user interface in response to receiving the NFC transmission from the point of sale terminal;
computer-readable program instructions to determine a strength of the NFC transmission received from the point of sale terminal;
computer-readable program instructions to display the NFC transmission signal strength on the user interface;
computer-readable program instructions to determine that the NFC transmission signal strength meets or exceeds a configured threshold; and
computer-readable program instructions to initiate a digital wallet application in response to the determination that the NFC transmission signal strength meets or exceeds a configured threshold.

9. The computer program product of claim 8, further comprising computer-readable program instructions to communicate a notification that the NFC transmission signal strength is above the configured threshold.

10. The computer program product of claim 9, wherein the notification is a vibration or an audible alert.

11. The computer program product of claim 8, wherein the NFC transmission signal strength displayed on the user interface is a bar graph.

12. The computer program product of claim 8, wherein the wireless transmission signal strength displayed on the user interface is a meter, gauge, or numerical representation.

13. A system to determine wireless field strength when conducting a wireless transaction, comprising:
a storage device; and
a processor communicatively coupled to the storage device, wherein the processor executes application code instructions that are stored in the storage device to cause the system to:
receive a wireless transmission from a point of sale terminal;
initiate a wireless transmission signal strength user interface in response to receiving the wireless transmission from the point of sale terminal;
determine a strength of the wireless transmission received from the point of sale terminal;
display the wireless transmission signal strength on the user interface;
determine that the wireless transmission signal strength meets or exceeds a configured threshold;
communicate a notification that the wireless transmission signal strength is above the configured threshold; and
present the digital wallet application on the user interface as the primary application in response to the determination that the wireless transmission signal strength meets or exceeds a configured threshold.

14. The system of claim 13, further comprising application code instructions to:
initiate a wireless transmission signal strength user interface in response to receiving the wireless transmission from the point of sale terminal; and
determine that the wireless transmission signal strength meets or exceeds a configured threshold.

15. The system of claim 13, further comprising application code instructions to:
communicate a notification that the wireless transmission signal strength is above the configured threshold; and
present the digital wallet application on the user interface as the primary application in response to the determination that the wireless transmission signal strength meets or exceeds a configured threshold.

16. The system of claim 13, wherein the notification is a vibration or an audible alert.

17. The system of claim 13, wherein the wireless transmission is a near field communication transmission.

18. The system of claim 13, wherein the wireless transmission is a Bluetooth, Wi-Fi, or infrared transmission.

19. The system of claim 13, wherein the wireless transmission signal strength displayed on the user interface is a bar graph.

20. The system of claim 13, wherein the wireless transmission signal strength displayed on the user interface is a meter, gauge, or numerical representation.
